(19) United States
(12) Patent Application Publication
(10) Pub. No.: US 2026/0091886 A1
(43) Pub. Date: Apr. 2, 2026

(54) INTEGRATED HELICOPTER AND DEPLOYMENT ENCLOSURE FOR PLANETARY EXPLORATION

(71) Applicant: AeroVironment, Inc., Arlington, VA (US)

(72) Inventors: Sara Langberg, Simi Valley, CA (US); Lindsay Sheppard, Simi Valley, CA (US); Michael Fillman, Simi Valley, CA (US); Paulina Ridland, Simi Valley, CA (US); Bart Dean Hibbs, Simi Valley, CA (US); Makoto Ueno, Simi Valley, CA (US)

(21) Appl. No.: 19/347,973

(22) Filed: Oct. 2, 2025

Related U.S. Application Data
(60) Provisional application No. 63/702,540, filed on Oct. 2, 2024.

(51) Int. Cl. B64G 1/00; B64G 1/56; B64U 10/13; B64U 20/50; B64U 30/24; B64U 50/37; B64U 70/90; B64U 80/10; B64U 101/75

(52) U.S. Cl. CPC B64G 1/00; B64G 1/56; B64U 10/13; B64U 20/50; B64U 30/24; B64U 50/37; B64U 70/90; B64U 80/10; B64U 2101/75

(57) ABSTRACT

The disclosed embodiments describe an integrated aerial exploration system for deployment on a planetary surface, the system including: a rotorcraft configured for flight in a low-density atmosphere and adapted to carry a scientific payload; an enclosure housing the rotorcraft during launch, transit, and landing, the enclosure including a mounting interface for attachment to a host vehicle and a cover movable to provide an opening for deployment of the rotorcraft; and a deployment mechanism configured, upon activation, to move the rotorcraft from within the enclosure to a position outside the enclosure through said opening; where activation of the deployment mechanism automatically releases the rotorcraft from the enclosure and deploys one or more stowed components of the rotorcraft into a flight-ready configuration for aerial operation.

### CROSS-REFERENCE TO RELATED APPLICATION

This application claims priority to and the benefit of U.S. Provisional Ser. No. 63/702,540 , filed Oct. 2, 2024, which is incorporated herein by reference in its entirety for all purposes.

### TECHNICAL FIELD

Embodiments relate generally to unmanned aerial vehicles (UAV), and more particularly to UAVs for extraterrestrial surface exploration.

### BACKGROUND

Extraterrestrial missions utilize ground-based rovers that are limited in their capabilities. These rovers may search for evidence of past microbial life and to study the planet's geology and climate history. The distance range of rovers may be limited by technology, mission design, and operational lifespan. For example, wheel durability and component reliability may limit a range for these ground-based rovers.

### SUMMARY

The disclosed embodiments describe an integrated aerial exploration system for deployment on a planetary surface, the system including: a rotorcraft configured for flight in a low-density atmosphere and adapted to carry a scientific payload; an enclosure housing the rotorcraft during launch, transit, and landing, the enclosure including a mounting interface for attachment to a host vehicle and a cover movable to provide an opening for deployment of the rotorcraft; and a deployment mechanism configured, upon activation, to move the rotorcraft from within the enclosure to a position outside the enclosure through said opening; where activation of the deployment mechanism automatically releases the rotorcraft from the enclosure and deploys one or more stowed components of the rotorcraft into a flight-ready configuration for aerial operation.

An integrated aerial exploration system embodiment for deployment on a planetary surface may include: a rotorcraft configured for flight in a low-density atmosphere and adapted to carry a scientific payload; an enclosure housing the rotorcraft during launch, transit, and landing, the enclosure including a mounting interface for attachment to a host vehicle and a cover movable to provide an opening for deployment of the rotorcraft; and a deployment mechanism configured, upon activation, to move the rotorcraft from within the enclosure to a position outside the enclosure through said opening; where activation of the deployment mechanism automatically releases the rotorcraft from the enclosure and deploys one or more stowed components of the rotorcraft into a flight-ready configuration for aerial operation.

In additional system embodiments, the rotorcraft comprises a coaxial dual-rotor helicopter having two counter-rotating rotors mounted on a common mast and no tail rotor, for providing lift and directional control in the low-density atmosphere. In additional system embodiments, the rotorcraft includes a payload interface configured to support the scientific payload of at least about 1 kilogram (kg), allowing the rotorcraft to carry one or more scientific instruments during flight.

In additional system embodiments, the cover of the enclosure may be a hinged top lid, and the deployment mechanism comprises an actuator that raises a platform on which the rotorcraft may be mounted, thereby lifting the rotorcraft upward and out through the opening created by the open lid. In additional system embodiments, the rotorcraft has foldable landing legs that may be restrained within the enclosure when the rotorcraft may be stowed, and where raising the platform causes the landing legs to unfold and an electrical connector linking the rotorcraft to the enclosure to disconnect without manual intervention.

In additional system embodiments, the enclosure comprises a mounting plate with a bolt pattern conforming to a standardized spacecraft interface, allowing the system to be mounted to the host vehicle using pre-existing attachment points. In additional system embodiments, the rotorcraft further comprises an onboard communication system configured for direct wireless communication with a remote receiver or relay orbiting said planetary surface, without requiring a communication relay through the host vehicle during flight. In additional system embodiments, the rotorcraft includes at least one of: ground mobility and manipulation features as part of said scientific payload, selected from the group consisting of: deployable wheels for surface driving and a robotic arm for sample acquisition, the enclosure being dimensioned to accommodate said features in the stowed configuration.

In additional system embodiments, a combined mass of the rotorcraft and the enclosure may be less than about 35 kilograms, making the integrated system suitable as a secondary payload on a planetary lander. In additional system embodiments, said planetary surface may be Mars and the rotorcraft may be configured to perform controlled flight in the Martian atmosphere with a flight endurance of 2-3 minutes and a flight range of at least 1 kilometer per flight.

In additional system embodiments, the deployment mechanism may be configured to deploy the rotorcraft vertically upward from the enclosure when the enclosure may be mounted on a horizontal surface of the host vehicle, and where the deployment mechanism may be reconfigured to deploy the rotorcraft outwardly when the enclosure may be mounted on a vertical surface of the host vehicle.

Additional system embodiments may include at least one of: one or more safety interlocks and sensors to verify that the cover may be open to a sufficient position before the rotorcraft may be moved by the deployment mechanism, and to confirm release of the rotorcraft before initiating flight, thereby preventing inadvertent rotorcraft activation while it may be partially stowed. In additional system embodiments, the enclosure includes dust seals around the cover to inhibit dust and debris be from entering the enclosure prior to deployment, thereby protecting the rotorcraft during descent and after landing. In additional system embodiments, the rotorcraft may be configured to be at least partially powered or recharged by the host vehicle prior to deployment via an electrical connector between the rotorcraft and the enclosure, and where said electrical connector may be the component that automatically disconnects upon deployment.

In additional system embodiments, the deployment mechanism and the rotorcraft may be arranged such that center of gravity of the rotorcraft remains within a stable range relative to a platform throughout deployment, thereby ensuring the rotorcraft stands upright on the surface when released. In additional system embodiments, the enclosure further comprises one or more vibration-damping supports positioned to contact portions of the rotorcraft during launch and landing, said supports preventing excessive movement or stress on those portions by absorbing vibration and shocks.

A method embodiment may include: receiving, by an enclosure, a deployment command; releasing a top cover latch restraining a lid of the enclosure in response to the deployment command; opening the lid of the enclosure once the top cover latch may be released; releasing one or more launch locks once the lid may be open; lifting a helicopter out of the enclosure on a platform via an actuator once the one or more launch locks may be released; deploying one or more landing legs of the helicopter once the helicopter may be lifted and clears the enclosure; and disconnecting an electrical connector linking the helicopter to the enclosure once the helicopter may be lifted to a separation point.

Additional method embodiments may include: launching the helicopter from the platform. Additional method embodiments may include: retracting the platform into the enclosure once the helicopter may be launched. Additional method embodiments may include: closing the lid of the enclosure once the platform may be retracted.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1A depicts a perspective view of an exemplary coaxial rotorcraft, according to one embodiment;

FIG. 1B depicts a perspective view of a coaxial rotorcraft, according to one embodiment;

FIG. 2 depicts a perspective view of an integrated aerial exploration system in a stowed configuration prior to deployment, according to one embodiment;

FIG. 3A is a perspective view of the system of FIG. 2 during a deployment sequence, according to one embodiment;

FIG. 3B is another perspective view of the system of FIG. 2 during the deployment sequence, according to one embodiment;

FIG. 4 depicts a schematic view of the enclosure and deployment mechanism, detailing internal components, according to one embodiment;

FIG. 5 depicts a bottom view of the enclosure showing a mounting plate with a standardized bolt pattern for attachment to a lander or rover, according to one embodiment;

FIG. 6A depicts a perspective view of an integrated aerial exploration system in a stowed configuration prior to deployment, according to one embodiment;

FIG. 6B depicts a perspective view of the system of FIG. 6A during a deployment sequence, according to one embodiment;

FIG. 7A depicts a perspective view of an integrated aerial exploration system in a stowed configuration prior to deployment, according to one embodiment;

FIG. 7B depicts a perspective view of the system of FIG. 7A during a deployment sequence, according to one embodiment;

FIG. 8A depicts a perspective view of an integrated aerial exploration system in a stowed configuration prior to deployment, according to one embodiment;

FIG. 8B depicts a perspective view of the system of FIG. 8A during a deployment sequence, according to one embodiment;

FIG. 9A depicts a perspective view of an integrated aerial exploration system in a stowed configuration prior to deployment, according to one embodiment;

FIG. 9B depicts a perspective view of the system of FIG. 9A during a deployment sequence, according to one embodiment;

FIG. 10A depicts a perspective view of an integrated aerial exploration system in a stowed configuration prior to deployment, according to one embodiment;

FIG. 10B depicts a perspective view of the system of FIG. 10A during a deployment sequence, according to one embodiment;

FIG. 11 depicts a high level flowchart of a method embodiment for deploying a rotorcraft from an integrated aerial exploration system on a planetary surface, according to one embodiment;

FIG. 12 illustrates an example top-level functional block diagram of a computing device embodiment;

FIG. 13 shows a high-level block diagram and process of a computing system for implementing an embodiment of the system and process;

FIG. 14 shows a block diagram and process of an exemplary system in which an embodiment may be implemented; and

FIG. 15 depicts a cloud computing environment for implementing an embodiment of the system and process disclosed herein.

### DETAILED DESCRIPTION

The present embodiments provide an integrated helicopter-and-enclosure system for planetary exploration that fulfills the aforementioned needs. The embodiments combine a compact, high-performance rotorcraft with a protective housing and deployment mechanism, forming a self-contained module that may be attached to a spacecraft and later releases the helicopter on the planetary surface.

There is a need for a modular aerial exploration system for extraterrestrial exploration. Such a system should be integrated into a variety of lander or rover platforms so as to minimize custom accommodations, provide sufficient capacity for scientific instruments, ensure a simple and robust deployment sequence, and leverage proven technologies that may be tuned for different mission needs.

The disclosed embodiments provide a self-contained helicopter with its own accommodation enclosure that has system mass of approximately 30-40 kilograms (kg), for example, 35 kg. The enclosure deploys a helicopter capable of delivering, for example, up to a 1 kg payload capacity, 2.5-minute flights, and greater than 1.2 kilometer (km) range. The volume required on a host vehicle for the closed system may be 0.33 meters (m) wide by 2.2 m long by 0.55 m tall and may have an estimated mass of 35 kg, including the 6 kg helicopter. In addition to the closed volume, the action of deploying the helicopter may take up approximately 0.35 m along the width, mostly towards the top and front side, to allow for the opening lid. Other dimensions are possible and contemplated.

Self-Contained Module: The helicopter and its deployment enclosure form a single packaged unit. The enclosure serves as a structural container during all mission phases (e.g., launch, cruise, entry/descent, and landing) and includes standardized mounting interfaces and electrical connections to the host spacecraft. This modular design greatly simplifies integration - the host vehicle treats the system like any other payload, avoiding elaborate custom deployment structures.

Coaxial Helicopter with Payload Capacity: The rotorcraft is a coaxial (i.e., dual rotors on one mast) helicopter optimized for flight in a low-pressure atmosphere. In a representative embodiment, the helicopter has a total mass of about 6 kg and is capable of carrying approximately 1 kg of scientific payload (e.g., cameras, sensors, and/or small robotic actuators). This is a significant increase in capability over prior art, enabling missions such as detailed scientific surveys, sample pickup and transport, and/or extended scouting of terrain.

Integrated Deployment Mechanism (Top-Opening Enclosure): The enclosure features a movable lid or cover (e.g., a top-hinged door) and an internal lifting platform. Upon command, the lid opens, and the platform raises the helicopter out of the enclosure. The deployment is largely passive and automatic: as the helicopter is lifted, its stowed components (landing legs, rotor blades) unfold into their operational configuration, and a power/communication tether disconnects. Only a minimal number of actuators (e.g., potentially just one motor for lifting) are needed to achieve full deployment, thereby maximizing reliability.

Heritage Design & Scalability: The system leverages supporting design elements, such as, rotor technology, control algorithms, and materials to reduce development risk, examples of which are disclosed herein. These supporting elements may be scaled up and refined to meet higher payload and range requirements. The architecture is inherently scalable: design parameters (e.g., rotor size, battery capacity, and enclosure dimensions) may be adjusted to create smaller or larger versions of the system for different mission profiles, without departing from the core embodiments. In operation, the integrated system may be mounted on a Mars lander or rover and launched from Earth. After landing on Mars, the system deploys the helicopter which can then conduct multiple flights to carry out science or support activities (e.g., ferrying objects and/or scouting paths). The host lander/rover is free of the burden of complex deployment tasks. At most, host lander/rover only may need to send a command to the helicopter module and provide power/data until deployment.

The embodiments disclosed herein present a turnkey aerial exploration solution: a ready-to-fly Mars (or other planetary) helicopter with its own “mini-lander” enclosure. These embodiments streamline mission integration, enhance science return by allowing mobile instruments, and maintain high reliability through design simplicity and use of flight-proven concepts.

The embodiments will now be described in detail by reference to the figures. While specific embodiments are described to exemplify the invention, it will be appreciated that modifications and variations may be made without departing from the spirit and scope of the inventive concepts.

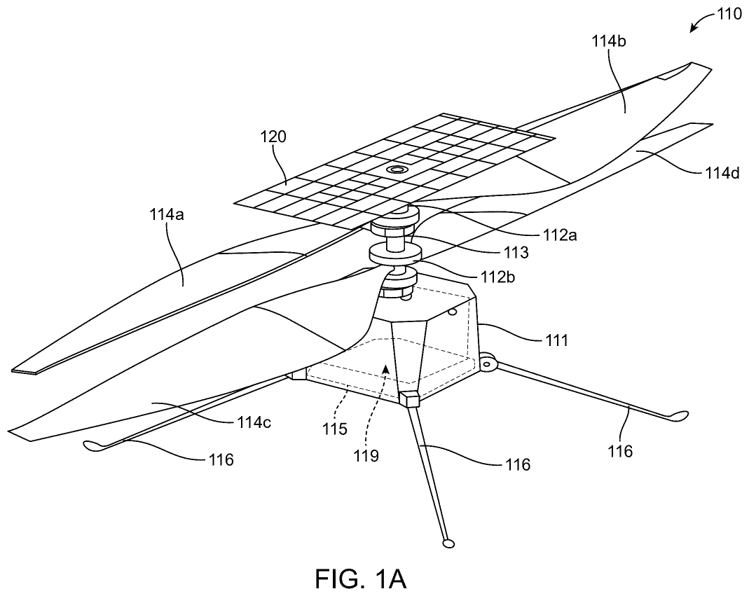

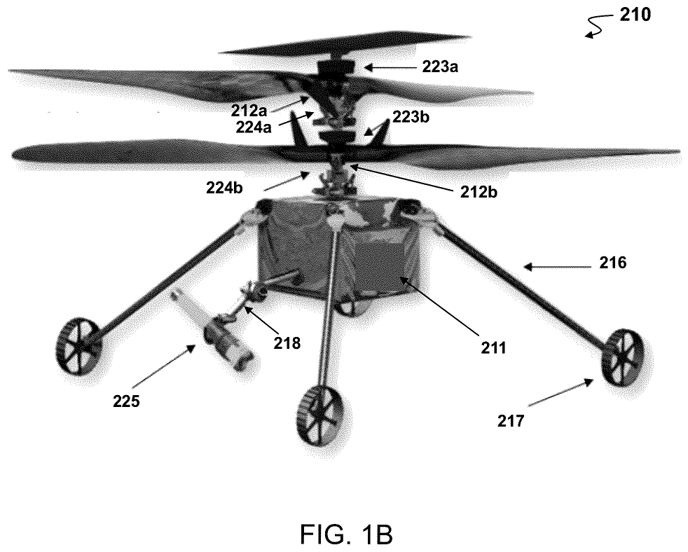

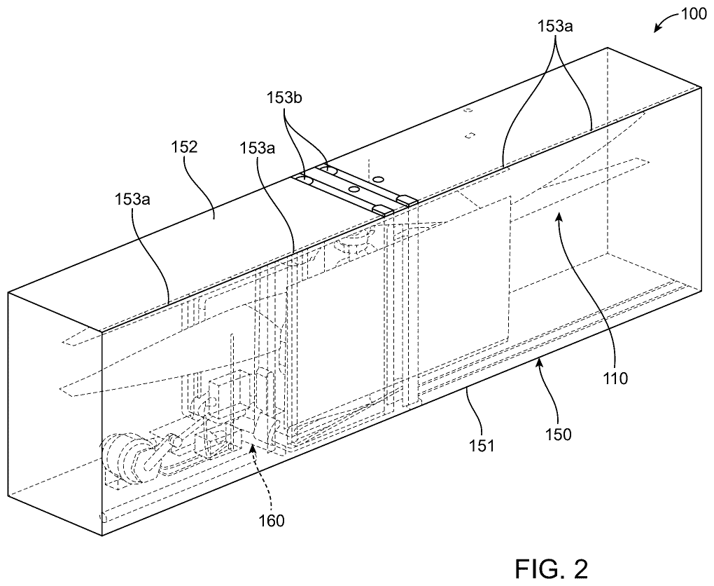

Referring initially to FIGS. 1A through 3B, a preferred embodiment of the integrated aerial exploration system is shown. The system, generally designated as 100, comprises two main subsystems: a rotorcraft (110, FIG. 1A) and a protective enclosure (150, FIG. 2). In this embodiment, the system 100 is configured for the exploration of Mars, though the design may be adapted for other planetary bodies with atmospheres.

FIG. 1A depicts a perspective view of an exemplary coaxial rotorcraft 110 (e.g., helicopter) in an unfolded, flight-ready state. The coaxial rotorcraft 110 is removed from its enclosure for clarity. The coaxial rotorcraft 110 is shown with two counter-rotating rotors and a set of landing legs. In this illustration, the rotorcraft is sized for Mars operation, with a rotor diameter on the order of 2 m and a dedicated payload mounted at the bottom of the fuselage.

### FIG. 1b is a Perspective View of a Coaxial Rotorcraft 210 in an Unfolded, Flight-ready state.

FIG. 2 is a perspective view of the integrated aerial exploration system 100 in its stowed configuration prior to deployment. The helicopter is folded and secured inside the enclosure, and the top lid of the enclosure is closed. The system is shown as it would appear attached to a host spacecraft (mounting details omitted for clarity in this view).

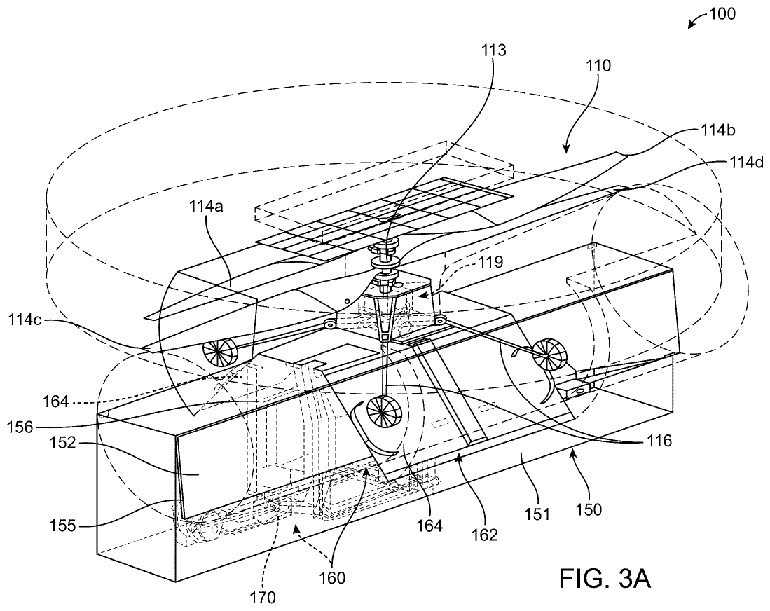

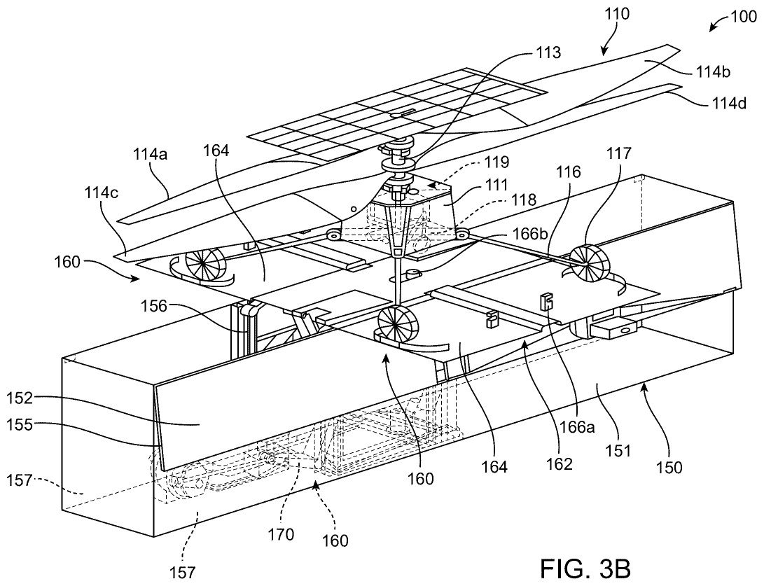

FIG. 3A is a perspective view of the system 100 during a deployment sequence. The top lid of the enclosure is open, and the internal lifting platform is raising the helicopter out of the enclosure. The landing legs of the helicopter are shown in the process of unfolding. FIG. 3A illustrates how the rotorcraft clears the enclosure and transitions toward a flight-ready state upon deployment.

FIG. 3B is another perspective view of the system 100 during the deployment sequence. In FIG. 3B, the helicopter is fully lifted out of the enclosure.

Rotorcraft (110): As depicted in FIG. 1A, the rotorcraft 110 is a coaxial helicopter specifically engineered for low-density atmospheric flight. It has a fuselage or body 111 that houses the avionics, power source, and payload 119; and a dual-rotor assembly consisting of an upper rotor 112a and a lower rotor 112b mounted on a shared mast 113. The coaxial rotors 112a, 112b turn in opposite directions to provide lift and control without needing a tail rotor (the counter-torque is balanced internally). This configuration provides a compact footprint, which is beneficial for stowage in the enclosure (150, FIG. 2), and inherits stability and control techniques (e.g., thrust vectoring via cyclic blade pitch). The mast, or central spine, 113 is connected to the body 111, and the body 111 of the helicopter 110 may house avionics, battery, and a communication system. In some embodiments, the mast 113 may be made of carbon-fiber but is not limited thereto. Other component materials are possible and contemplated.

Each rotor 112a, 112b has multiple blades 114a, 114b, 114c, 114d (e.g., two blades per rotor in this embodiment). The blades, 114b, 114c, 114d are crafted from lightweight composite material (e.g., carbon fiber) with an internal foam core for stiffness. Other materials are possible and contemplated. The rotor diameter in this embodiment is approximately 2.1 m tip-to-tip, giving sufficient disk area to lift the combined mass of the helicopter 110 and its payload 119 in Martian gravity. The rotorcraft 110 is capable of producing the required thrust with a margin. The rotorcraft 110 is designed to operate at a rotational speed (RPM) that keeps the blade tip Mach number in a safe range (e.g., for Mars, typically around 0.7-0.8 Mach in hover, to balance lift and compressibility effects). The control system of the rotorcraft 110 uses three or more swashplate actuators, or servos, (not individually shown) per rotor 112a, 112b to adjust blade pitch for lift (collective) and attitude control (cyclic), following the control architecture of prior coaxial helicopters. In FIG. 1B, two sets 224a, 224b of swashplate and multiple servo are arranged around the mast 113. The first set (224a, FIG. 1B) of swashplate and multiple servo changes the blade angles on a spinning upper rotor (212a, FIG. 1B) driven by a first motor (223a, FIG. 1B), and the second set (224b, FIG. 1B) of swashplate and multiple servo changes the blade angles on a spinning lower rotor (212b, FIG. 1B) driven by a second motor (223a, FIG. 1B). The landing gear of rotorcraft 110 may include landing legs 116 with a suspension that supports the helicopter 110 on the ground. In some embodiments, the landing legs 116 may consist of a set of springy legs 116 (e.g., four legs in the illustrated embodiment, attached at the lower corners of the body 111). In some embodiments, the legs 116 may be four spring-loaded carbon-fiber legs. These legs 116 are shown extended in FIG. 1A (flight configuration) and folded in FIG. 2 (stowed configuration). Each leg 116 is hinged near the body, or fuselage, 111 and biased outward by a spring element. In the stowed state within enclosure 150, the legs 116 are held folded upward (e.g., against the body 111 of the helicopter 110 or slightly retracted into recesses) to reduce the effective footprint. Upon release (during deployment), the legs 116 swing down and latch into a wide stance, absorbing impact and providing stability on the ground. The leg length and spread are chosen so that the center of gravity of the helicopter 110 remains well within a support polygon, ensuring it will not tip over on reasonably level ground. For reference, in the Mars-specific design, the center of gravity of the helicopter 110 might be ˜0.4 m above ground when on its legs 116, and the legs 116 spread out to cover a circle of about 0.75 m in diameter, a ratio that gives robust stability.

The payload capacity of rotorcraft 110 is a distinguishing feature. The helicopter 110 is designed to carry up to about 1 kg of non-flight-critical payload (e.g., instruments or tools not required for basic flight). This payload 119 is accommodated in a bay, or mounting area, 115 on the helicopter 110. In FIG. 1A, the payload bay 115 is indicated at the bottom of the body, or fuselage, 111 where a science instrument package could be attached. Examples of payloads 119 include: a high-resolution camera system for geological surveying, navigation, flight control, and tube location, a spectrometer for detecting water or mineral content from the air, a magnetometer to measure magnetic fields while flying, or as illustrated conceptually, a small robotic arm 118 (shown in phantom in FIG. 3B) and wheels 117 (shown in phantom in FIG. 3B) that could allow the helicopter 110 to pick up samples and drive short distances on the ground. These examples demonstrate the flexibility of the 1 kg allocation, which could be used for scientific sensors and/or for hardware to extend the capabilities of the vehicle (e.g., the wheels and arm may effectively turn the helicopter 110 into a hybrid flying/ground vehicle when needed). If a mission does not need a full 1 kg of dedicated instruments, that margin may be used for additional batteries or structural reinforcement, thereby extending flight time or adding robustness.

In some embodiments, as shown in the helicopter 210 of FIG. 1B, a robotic arm, or manipulator, 218 included as a payload inside the body 211 may be configured to extend out of a body 211. The robotic arm 218 may be a small 2-DOF arm with a two-fingered gripper, used to pick up metal sample tube 225 from the ground. The helicopter 210 may also include a ground mobility system, such as wheels, 217 attached to ends of landing legs 216, enabling it to “grab and go” with cached samples. These allow the helicopter 210 to drive short distances (˜a few meters) to position itself over a sample tube 225 or the drop zone of the lander. The wheels 217 may use a tank-like skid-steering approach (e.g., pairs on each side) to roll the helicopter 210 on Martian terrain.

The rotorcraft 110 carries its own power supply and electronics. In this embodiment, a rechargeable battery pack (e.g., lithium-based cells) is housed within fuselage 111 to provide the electrical power for rotor motors 123a, 123b and avionics. A solar panel 120, which could be mounted on the top of the rotorcraft 110 or on upper rotor disk of the rotorcraft 110, may be included to recharge the battery between flights using sunlight, for example, via a solar charging system. Alternatively or additionally, the battery may be charged by the lander via a tether while stowed. The avionics include a flight computer, inertial measurement units (gyros/accelerometers), altimeters, and cameras for navigation (e.g., down-looking terrain camera). These avionics are a supporting components design, and may be updated as needed for a larger vehicle.

The rotorcraft 110 also features a communications system, such as a radio transceiver, capable of establishing a link with a Mars orbiter or the lander. Notably, the design anticipates a direct-to-orbiter communication link, which might use UHF frequencies, allowing the helicopter to transmit data back to Earth (e.g., via the orbiter) without needing the lander as an intermediary. This is important for operational independence. In some embodiments, the helicopter 110 may also communicate with the lander/rover if needed for coordination or as a backup.

When fully deployed (FIG. 1A state), the helicopter 110 is a self-contained, autonomous flying vehicle, roughly the size of a medium drone, but engineered for Mars. The helicopter 110 has the lift and power to carry significant instruments and the sensing/communication capability to operate as part of a Mars mission. The helicopter 110 incorporates several improvements over the state-of-the-art, such as increased payload, direct communication, and potentially surface mobility additions. All these features are packaged within a frame that may be folded and stowed for transit, as described herein.

Enclosure 150 and Stowed Configuration: FIG. 2 shows the system 100 in the stowed configuration, where rotorcraft 110 is contained inside the enclosure 150. The enclosure 150 is essentially a protective box that serves three primary roles: (i) structural support of the helicopter 110 during launch and landing, (ii) environmental shielding (e.g., from shock, vibration, dust, debris, and/or thermal extremes), and (iii) housing a deployment mechanism 160 that will release the helicopter 110.

In the illustrated embodiment, the enclosure 150 has a rectangular box shape sized to just accommodate the folded helicopter 110. Its interior volume is slightly larger than a stowed form of the helicopter 110, allowing clearance for any components that stick out, such as parts of the landing gear, the landing legs, (116, FIG. 1A), and/or the rotor hub (112a, 112b, 113, FIG. 1A). For a 6 kg, ˜2 m rotor helicopter, internal dimensions of the enclosure might be on the order of 0.3 m×0.3 m in cross-section and about 0.55 m tall (to fit the rotor diameter and leg spread when folded). The enclosure walls 151 may be made of a lightweight, stiff material such as carbon-fiber composite panels, possibly with honeycomb cores for rigidity.

Other enclosure wall 151 materials are possible and contemplated. These walls 151 provide a rigid cage that can withstand the intense vibrations and forces of launch (e.g., several times the force of gravity in random vibration) and the deceleration and shocks of Mars landing, thereby protecting the helicopter 110 inside from mechanical stress.

One side of the enclosure 150 is an openable cover, or lid, 152. In this embodiment, the cover 152 is the entire top panel (hence “top-deploy” design). The top cover 152 is attached to the enclosure 150 via a hinge 153a along one edge, allowing it to swing open like a door (see FIGS. 3A and 3B). A latch mechanism 153b secures the lid 152 closed during the phases up to deployment. The latch 153b may be a motorized lock or a pyrotechnic pin puller. In some embodiments, the latch 153b may be a motorized or spring-latch for reusability. The lid 152, when closed, forms a sealed barrier, or dust seal, 155 (with sealing means discussed below) to keep dust and debris out. The hinge 153a and latch 153b are designed to be robust against jamming by contaminants and to remain functional after potentially months or years of inactivity (e.g., transit to Mars plus surface wait time). Opening the lid 152 triggers the release of an upper launch lock 166a (not explicitly drawn, but located near the top of the mast 113 inside the box 150) that holds the helicopter 110 during landing. The mounting interface for attaching enclosure 150 to a host spacecraft is located on the exterior of the enclosure 150.

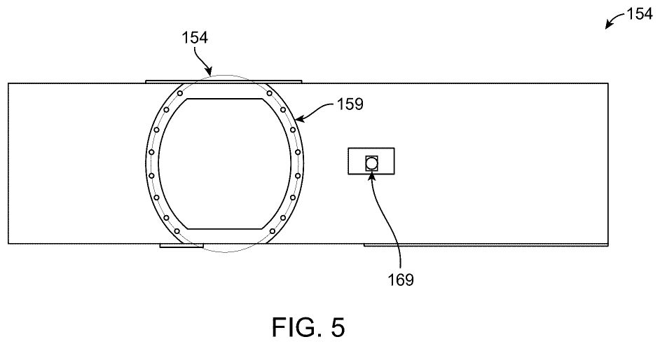

FIG. 5 depicts a bottom view of the enclosure showing a mounting plate 154 with a standardized bolt pattern (e.g., a 15-inch diameter pattern) for attachment to a lander or rover. FIG. 5 also indicates an alternative side mounting interface on one wall of the enclosure. The location of the primary electrical connector port 169 on the bottom of the enclosure is shown.

FIG. 5 illustrates an embodiment where the bottom face of the enclosure (150, FIG. 2) carries a mounting plate 154 with a standard bolt-hole pattern 159, such as a 15-inch diameter ESPA ring pattern (i.e., commonly used for secondary payload mounting on space vehicles). This allows the entire system (100, FIG. 2) to be bolted onto a lander deck or rover body using industry-standard fasteners and procedures. In FIG. 5, an embodiment may include one or more bolt positions, for example, 16 or 24 bolt positions are shown (as per a typical ESPA interface), though not all need to be used if the loads are within limits. The enclosure (150, FIG. 2) could also have a similar interface on a side face (as an alternative, for side-mounting) which may be identical or a different pattern. The ability to mount either on the bottom or side gives mission designers flexibility. For example, a lander might carry the helicopter (110, FIGS. 1A and 2) on its top deck (e.g., bottom-mounted enclosure), or on a side panel (e.g., side-mounted, possibly if deploying similarly to a side hatch). In any case, the mounting interface is designed to carry the full weight of the system (100, FIG. 2) plus launch loads with a healthy safety margin (e.g., 4×safety factor), ensuring the system (100, FIG. 2) may be treated like any other spacecraft component during integration.

For connections between the host vehicle and the enclosure (150, FIG. 2), an electrical connector 169 (e.g., socket) may be mounted on the mounting plate 154 at the bottom of the enclosure (150, FIG. 2). This connector 169 may be used to provide power to the helicopter (110, FIGS. 1A and 2). In one example, the connections may be MIL-DTL-38999 Series III socket with MIL-STD-1560 15 35 male pins where the connector may have 37 available contacts which may be used to provide power to the helicopter and provide health status until helicopter deployment.

Inside the enclosure 150, the rotorcraft 110 is held firmly in place by the deployment mechanism 160, shown schematically in FIGS. 2-4. This mechanism 160 both secures the helicopter 110 during transport and performs the deployment action when commanded. Embodiments of the components of deployment mechanism 160 may include: a Base Platform 162; Foldable Side Panels 164; Launch Locks 166a, 166b; Vibration Dampers (Snubbers); Actuator Assembly 170; and Electrical Connector.

Base Platform 162: A support plate or cradle on which the helicopter 110 rests. In the stowed configuration (FIG. 2), the weight of the helicopter 110 may be carried by this platform 162. The platform 162 spans cross-sections of the enclosure 110 and may move vertically within the enclosure 110 (e.g., guided by rails, or slots, 156 on the side walls 157 of the enclosure 150, by the actuator mechanism, and/or by the actuator assembly, 170 itself). The bse platform 162 acts like an elevator floor to lift the helicopter 110 up and out. As the helicopter 110 lifts, it passively unfolds the landing legs 116 and disconnects the power/communication umbilical. In the diagram, the platform 162 is shown in its raised position with the helicopter 110 on top.

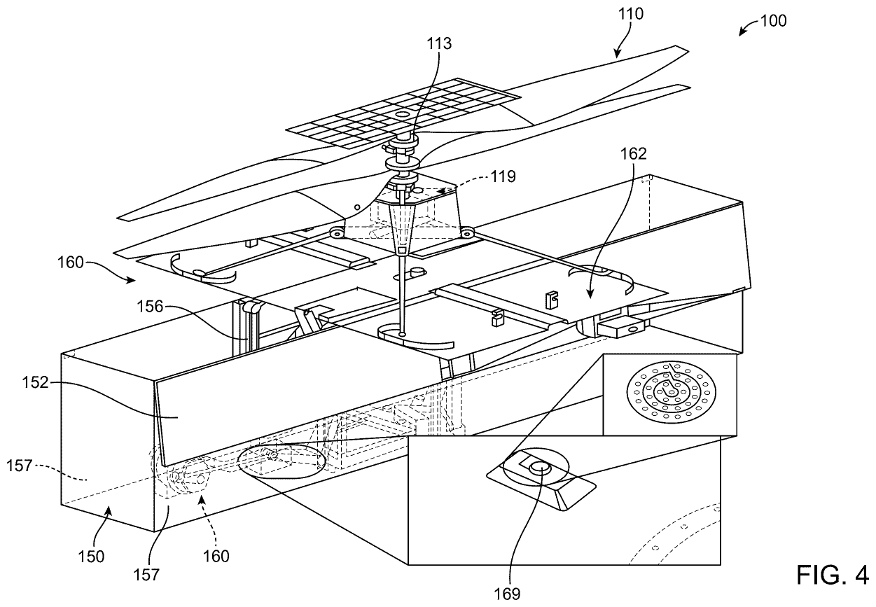

Foldable Side Panels 164: In one embodiment, the base platform 162 has short sidewall extensions that fold up around a lower portion of the helicopter 110 to constrain it laterally. In FIG. 4, these panels 164 are shown in a folded-up position forming a partial box around a base of the helicopter 110. They ensure the landing legs 116 (when folded) and any other protrusions are snugly contained, preventing them from rattling or shifting. When the base platform 162 moves upward during deployment, these panels 164 may be designed to hinge down or otherwise get out of the way (e.g., they might be spring-loaded to flop outward once no longer constrained by the enclosure walls 157, thus not obstructing the helicopter 110 as it exits). In some designs, these panels 164 might also serve as ramps or guides if the helicopter 110 were to slide out, but in the preferred top-deploy design they mainly add structural support during stowage.

Launch Locks 166a, 166b: As shown in FIG. 3B, at least two restraining connection points secure the helicopter 110 to the enclosure 150 during transit: a lower launch lock 166b near a bottom (or center of mass) of the helicopter 110 and an upper launch lock 166a near the top of the helicopter 110. These locks 166a, 166b are shown in FIGS. 3A to 4 as attaching to the mast 113 (for the upper lock 166a) of the helicopter 110 and to the lower frame or landing assembly (for the lower lock 166b). In one embodiment, the lower launch lock 166b is a clamping bracket that grabs a strong point on the helicopter 110 (such as a structural node where landing legs 116 attach or a dedicated interface on the bottom of the fuselage 111). These locks 166a, 166b hold the helicopter 110 in all directions, effectively making the helicopter 110 and platform 162 move as one unit. These locks 166a, 166b could be a bolted joint or a spring-pin that engages a fitting on the helicopter 110.

The upper launch lock 166a is designed to constrain a top end of the helicopter 110 (to avoid wobble or vibration) primarily in lateral directions but not over-constrain it. For example, it may be a collar that encircles the mast 113, preventing it from tipping or moving side-to-side, but allowing a small amount of axial movement (sliding along the mast 113) and rotation. This two-point restraint (a firm lower clamp and a compliant upper guide) ensures that the helicopter 110 is held rigidly enough to endure launch loads without its own structure bending or resonating excessively. The enclosure structure 150 may be made significantly stiffer than the helicopter 110 by locking the helicopter 110 to the enclosure 150 at these points, such that the helicopter 110 effectively “borrows” rigidity of the enclosure 150. The slight compliance in the upper lock 166a means that if the enclosure 150 flexes or thermal expansion occurs, the helicopter 110 isn't crushed or bent between the locks 166a, 166b.

In some embodiments, the system 100 may further comprise one or more launch locks, or interlocks, 166a, 166b and/or one or more sensors to verify that the cover 152 is open to a sufficient position before the rotorcraft 110 is moved by the deployment mechanism 160, and to confirm release of the rotorcraft 110 before initiating flight, thereby preventing inadvertent rotorcraft activation while it is partially stowed.

Vibration Dampers (Snubbers): the enclosure 150 can include one or more vibration-damping supports, such as soft supports or pads that press gently against delicate parts of the helicopter 110 to damp vibrations. For instance, small blocks or rings of foam may be placed where they touch the rotor blade tips or the ends of folded legs 116. These snubbers cushion the components during the violent shaking of launch, preventing them from flapping or chattering. They are positioned so as not to stick to or interfere with the helicopter 110 when it deploys. In essence, they act as shock absorbers for any parts of the helicopter 110 that are not directly locked down by the launch locks 166a or 166b.

Actuator Assembly 170: This is the powered mechanism that moves the base platform 162 (and thus the helicopter 110) upward to deploy. It can take several forms. For example, a lead screw driven by an electric motor, a rack-and-pinion gear, a linear actuator, and/or a scissor jack mechanism. In the illustrated embodiment, a screw jack is mounted under the platform 162 at bottom center of the enclosure 150. When the deployment command is issued, this actuator 170 extends, pushing the platform 162 (and helicopter 110) upward. Electric actuation is preferred for fine control and the ability to stop/reverse if needed. The actuator assembly 170 is designed to have enough force to lift the helicopter 110 (in Martian gravity, 6 kg weighs about 2.3 kg) plus overcome any stiction in the mechanism, with margin. On Earth, during testing, it would need to lift the full 6 kg (plus test fixture weight), which is taken into account in its sizing. If redundancy is required, two actuators could be used, but one is sufficient in the basic design because mechanical binding is minimized by guides.

Electrical Connector: While not a restraining “lock” per se, a connector system provides electrical interface between the helicopter 110 and the enclosure 150 (and thus to the host vehicle/lander/rover) so that it is provided power and data from the host vehicle while stowed.

FIG. 4 depicts a cutaway or schematic view of the enclosure and deployment mechanism, detailing internal components. [[Visible are the mounting interface at the base of the enclosure, the upper and lower launch locks that secure the helicopter, the lifting platform and its actuator, the electrical connector linking the helicopter to the enclosure, and foldable side panels of the platform that support the helicopter during stowage.]]

In FIG. 4, the connector (e.g., a plug interface) may be mounted in the bottom of the helicopter 110, plugging into a socket 169 on the enclosure platform 162 (or vice versa). This connector serves to keep the battery of the helicopter 110 charged during the cruise and to allow communication lines (e.g., for health monitoring, software updates, etc.) between the helicopter 110 and the host vehicle prior to deployment. It may carry power, data, and possibly discrete signals (e.g., a “deploy readiness” status). Importantly, this connector is designed to automatically disconnect at the right time in the deployment sequence. A common approach is to use a “breakaway” plug: for instance, the socket 169 is fixed on the enclosure 150, and the plug is attached to the helicopter 110; when the helicopter 110 is lifted, the plug simply pops out of the socket 169 once the slack is gone, making the helicopter 110 free-standing on its own battery. Spring contacts or latching connectors with a release mechanism may be used to ensure a clean separation without damage. The connector may incorporate a slight spring-loading so that it pushes itself apart when not held together, aiding separation.

In one embodiment, the deployment sequence from stowed (FIG. 2) to deployed (FIGS. 3A and 3B) may be described by the following steps.

Step 1: Initiation. The host vehicle (e.g., lander or rover) sends a deployment command to the enclosure 150 (alternatively, the enclosure 150 could have an automatic timer or sensor logic to decide when to deploy, but typically ground command is used for control). The helicopter system 100 might first perform any self-checks (e.g., battery charge status, helicopter systems go) before mechanical actions commence.

Step 2: Lid Release and Opening. The top cover latch 153b is released. In one implementation, a small electric motor or solenoid withdraws a locking pin. In another, pyrotechnic bolts sever a restraint (though reusability favors a non-pyro solution). Once unlatched, the lid 152 is pushed open. Gravity on Mars is about one-third of Earth's, but still sufficient for a spring-loaded hinge to push the lid 152 open if designed to do so. Alternatively, a dedicated actuator can open the lid 152 fully. For reliability, a simple spring or torsion bar can ensure the lid 152 swings open to a predetermined angle (e.g., fully 180° open, or at least a wide angle like 120°) and then a damper may slow it at the end to avoid shock. FIGS. 3A-3B shows lid 152 in the open position. Opening the lid 152 immediately removes the support holding down the helicopter 110 from above. At this moment, the upper launch lock 166a is still engaged (holding the mast 113), so the helicopter 110 doesn't move, but any constraints that might have been attached to the lid 152 (some designs might anchor rotor blades 114a to 114d to the lid 152 to save space) are freed.

Step 3: Unlock Sequence. In coordination with lid 152 opening, the mechanism triggers the release of the launch locks 166a and 166b. This may be done in various ways. For example, the action of the lid 152 might mechanically pull a linkage that releases the upper lock 166a. In one embodiment, the upper lock 166a may have been secured by a pin that was connected by a cable to the lid 152. As the lid 152 opens, it yanks the pin out, freeing the mast 113 at the top. The lower lock 166b might be released by the upward force of the platform 162 when it starts moving (if, e.g., the lower lock 166b is attached to the platform 162 and the helicopter 110, a slight motion could disengage a latch). Alternatively, pyrotechnic or electric releases at each lock 166b may be fired, though the goal is to minimize the number of active releases. If only one actuator 170 (the platform 162 lift) is used, one design may have the locks 166b shaped such that once the platform 162 begins to lift, the geometry automatically disengages them (e.g., a hook that slides out of a slot at a certain angle). In this embodiment, we can assume the locks 166a, 166b are now free, meaning the helicopter 110 is no longer rigidly bolted to the enclosure 150. However, initially gravity still keeps it on the platform 152, and friction in the system 100 prevents any sudden motion.

Step 4: Lifting the Helicopter. The actuator 170 now engages to raise the platform 162. Because the launch lock 166b was attaching the helicopter 110 to the platform 162, the helicopter 110 comes up together. This is a slow, controlled movement (e.g., taking perhaps a few seconds to fully extend). As the platform 162 ascends, the helicopter 110 gradually emerges through the open top of the enclosure 150 (FIGS. 3A and 3B). The design ensures that by the time the platform 162 is fully raised, the landing legs 116 of the helicopter 110 may be above the enclosure walls 151. The helicopter 110 clears the box 150.

Step 5: Automatic Deployment of Legs and Other Components. As the helicopter 110 rises and clears the confines of the enclosure 150, the landing legs 116 are free to swing down into position. During stowage, the legs 116 were folded and likely held by the enclosure walls 151 or by small restraining clips. Once free, either gravity or springs cause the legs 116 to rotate to their extended positions. There may be detents or locks that click to keep them extended and rigid for landing. FIG. 3A illustrates two legs 116 already extended and the other two 166 in motion (depending on the perspective). Additionally, if the rotor blades 114a to 114d were locked or partially folded, they now deploy. In the coaxial design, full blade folding might not be necessary for storage because the rotor blades 114a to 114d may be aligned to fit in the rectangular box 150 (e.g., oriented diagonally). However, sometimes blades 114a, 114b, 114c, 114d may be strapped to prevent flapping. If so, those straps would either have been attached to the lid 152 (and thus removed when the lid opened) or to the platform 162 (and may be released by a small mechanism when lifting begins). The result is that by the time the helicopter 110 is fully lifted out, its legs 116 are down and its rotor blades 114a to 114d are unrestricted. The helicopter 110 is essentially in the same configuration as it will be for takeoff.

Step 6: Electrical Disconnect. As the platform 162 nears the top of its travel, the electrical connector linking the helicopter 110 to the enclosure 150 reaches its separation point. The connector is designed to separate easily. In one embodiment, the connector includes a plug-and-socket configuration, including a short tug that may unplug it. In practice, it might separate once the helicopter 110 has moved a few centimeters. This ensures the helicopter 110 is now running purely on internal power and communicating wirelessly (if it needs to talk to the lander). The system 100 may be configured to have the helicopter 110 automatically switch to its internal battery as soon as the external power is lost, without rebooting the system 100 (e.g., a seamless transfer or having been on battery the whole time).

Step 7: Placement and Release. The platform 162 reaches its fully raised position, which ideally is at or slightly above flush with the top opening of the enclosure 150. One design goal is not to lift the helicopter 110 too high, to maintain a low center of gravity when it's set down. If possible, stopping when the feet of the helicopter 110 are just an inch or two above the ground is ideal, then letting it drop that tiny distance or gently pushing it off. Optionally, little kicker springs can give the helicopter 110 a nudge to tip and rest on its legs 116 on the ground clear of the platform 110. Because the platform 162 may still be supporting part of the weight, some mechanism ensures the helicopter 110 fully dismounts: e.g., as mentioned, a slight push or a tilt of the platform 162 could do it. At this stage, any lingering connections (mechanical or electrical) are gone and the helicopter 110 stands on its own legs 116 on the Martian soil next to the enclosure 150 (FIG. 3B shows it just as it comes out, but the final state would have the helicopter 110 completely free).

Step 8: Retraction of Mechanism. After the helicopter 110 is free, the platform 162 of the enclosure 150 may retract a bit to avoid interfering with takeoff of the helicopter 110. In one embodiment, once the weight is off, the platform 162 may drop back down a few centimeters. The lid 152 may remain open (the helicopter 110 will likely take off soon, so an open lid 152 isn't an issue; it won't collide because the helicopter 110 takes off vertically). Alternatively, the lid 152 may be closed after deployment to protect the interior from the environment or to avoid being a protruding hazard on the lander. The mechanism disclosed herein allows either option. Throughout this sequence, the design minimizes simultaneous actions and uses mechanical passive events as much as possible. For example, a single motor controlling the lift may be the only powered motion; everything else (i.e., lid open, locks release, legs unfold, and plug disconnect) happens as a consequence of that motion and the pre-loaded spring biases. This greatly simplifies the control logic and reduces failure modes. If something does fail mid-sequence (e.g., if the lid 152 doesn't fully open), the system 100 can detect it (e.g., via switches or current monitoring on the motor) and abort or retry, since the motor can reverse and the helicopter 110 hasn't been thrown off and nothing irreversible has happened. This is in contrast to one-time pyrotechnic deployments which, if they misfire, cannot be corrected.

Now that the helicopter 110 is deployed and standing on the surface, it can commence its flight operations. The enclosure 150 has served its purpose as a “delivery cradle” and is no longer actively needed. It effectively becomes an empty box attached to the lander. Because it's lightweight, it doesn't significantly encumber the lander after deployment.

Several additional features and alternative embodiments may be integrated into the system 100 shown in FIGS. 1 to 5 without departing from the core invention. Dust Protection and Sealing. Mars is dusty, and when a lander touches down, it can spray regolith. The enclosure 150 is designed to be dust-tight when closed. As noted, the lid 152 includes a seal around its perimeter. In one embodiment, a brush seal is employed: flexible bristles line the gap between the lid 152 and walls 151, preventing fine dust from entering while allowing the lid 152 to swing freely.

Alternatively, rubber gaskets could compress when the lid 152 is latched. Any small penetrations in the enclosure 150 (e.g., bolt holes and cable feed-throughs) are likewise sealed or filtered. The enclosure 150 may have a small breather vent for pressure equalization (e.g., to prevent significant pressure difference inside vs. outside during landing or when temperature changes), but that vent is designed to block dust (e.g., covered with a Gore-Tex membrane or sintered filter that lets air out but not particles in). Such measures ensure that the helicopter 110 emerges clean and its mechanisms unjammed by debris.

Thermal and Radiation Considerations. The enclosure 150 provides some thermal insulation, which is beneficial during the cold Martian nights or the vacuum of space transit. If needed, the enclosure interior may house heating elements to keep the helicopter electronics and battery within operational temperatures prior to deployment. Power for these heaters may come via the electrical connector from the power system of the lander. The helicopter 110 itself is designed using radiation-tolerant components (e.g., radiation-hardened processors, etc.), so no special radiation shielding is required inside the enclosure 150. The temperatures during atmospheric entry on Mars are mostly handled by the heatshield of the entry capsule. The enclosure 150 of the helicopter 110 may rarely directly experience extreme aerodynamic heating. The deceleration and impact shocks of landing are accounted for in the structural design (e.g., mounting interface 154 and internal locks 166a, 166b), as previously described.

Resettable and Testable Mechanism: A significant advantage of this integrated design is that it is fully testable before launch. Since the deployment mechanism 160 uses no one-time-use components (in the preferred embodiment), engineers can run the deployment sequence on Earth multiple times to verify reliability. The helicopter 110 may be stowed, the lid 152 closed and latched, then commanded to deploy in Earth gravity (possibly with some support since Earth gravity is higher, or using a dummy weight to simulate Mars gravity). Any issues may be fixed, and the system reset (e.g., the platform 162 lowered, locks 166a, 166b re-engaged, lid 152 closed) for another test. This ability to verify the actual flight hardware's deployment gives confidence that it will work on Mars. Additionally, because everything remains attached (the helicopter 110 doesn't separate until it's safely on the ground), the risk of losing the helicopter 110 due to a hang-up or mis-timed latch 153b (e.g., pyro) is eliminated.

Alternate Enclosure Configurations. While the top-opening (i.e., vertical deploy) configuration is described, the system and method disclosed herein may also be realized with different enclosure geometries.

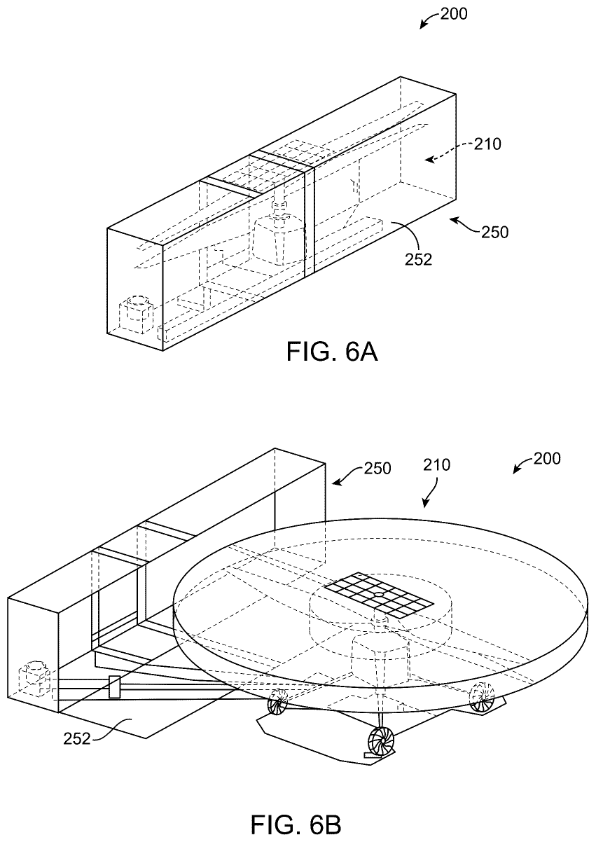

FIG. 6A depicts a perspective view of an integrated aerial exploration system in its stowed configuration prior to deployment, according to another embodiment.

The helicopter is folded and secured inside the enclosure, and door of the enclosure is closed.

FIG. 6B depicts a perspective view of the system during the deployment sequence. The door of the enclosure is open, and the internal deployment mechanism is releasing the helicopter out of the enclosure. In this side-deploy configuration, as shown in FIGS. 6A-6B , the enclosure 250 may open like a door 252 on one side (split in half vertically in some embodiments) and slide or swing the helicopter 210 out horizontally. The helicopter 210 might then drop a short distance to the ground or be lowered by a winch. This may be useful if a lander has more clearance to the side than above.

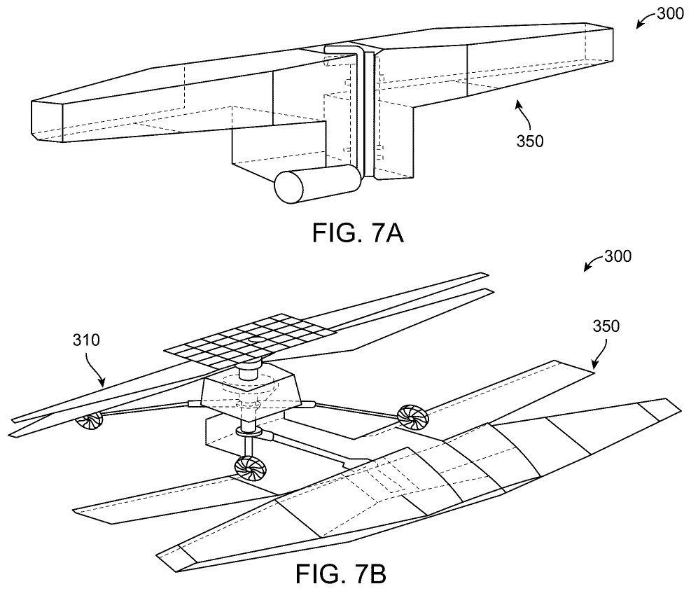

FIG. 7A depicts a perspective view of an integrated aerial exploration system 300 in its stowed configuration prior to deployment, according to one embodiment.

The helicopter 310 is folded and secured inside the enclosure 350, and the enclosure 350 is closed.

FIG. 7B depicts a perspective view of the system 300 of FIG. 7A during the deployment sequence. The enclosure 350 splits open in opposite directions, releasing the helicopter 310 out of the enclosure 350. In this clamshell configuration, as shown in FIGS. 7A-7B, the enclosure 350 may have two doors that open in opposite directions (e.g., like clam shells) revealing the helicopter 310, which may then either lift out or even take off directly from inside if enough clearance is given by the open halves.

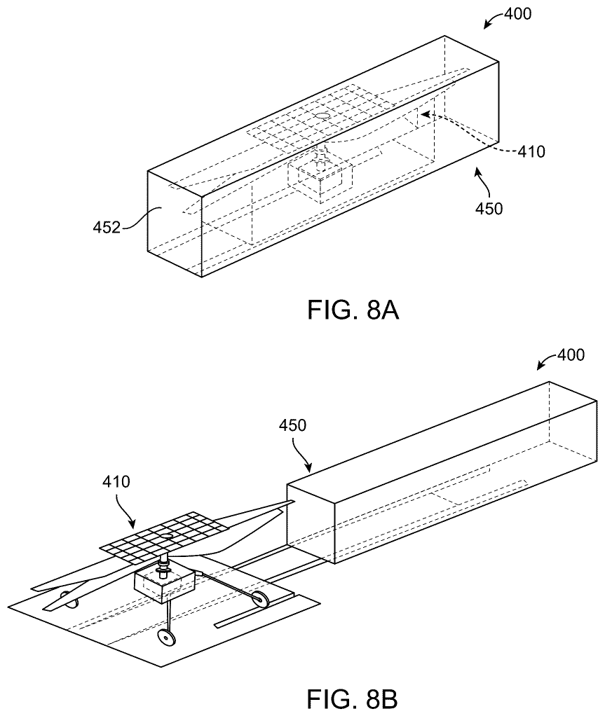

FIG. 8A depicts a perspective view of an integrated aerial exploration system 400 in its stowed configuration prior to deployment, according to one embodiment.

The helicopter 410 is folded and secured inside the enclosure 450, and the door 452 of the enclosure 450 is closed.

FIG. 8B depicts a perspective view of the system 400 of FIG. 8A during the deployment sequence. The door 452 of the enclosure 450 is open, and the internal deployment mechanism is releasing the helicopter 410 out of the enclosure 450.

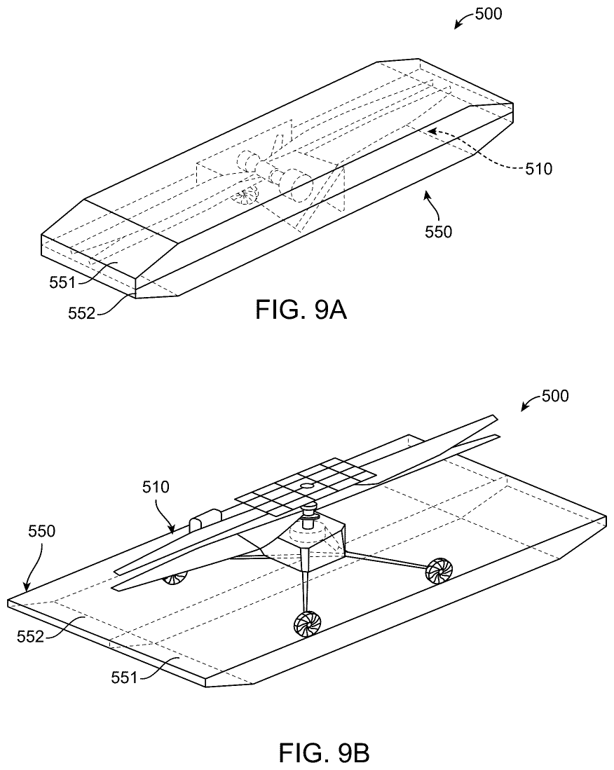

FIG. 9A depicts a perspective view of an integrated aerial exploration system 500 in its stowed configuration prior to deployment, according to one embodiment.

The helicopter 510 is folded and secured inside the enclosure, and the enclosure 550 is closed.

FIG. 9B is a perspective view of the system 500 of FIG. 9A during the deployment sequence. The upper enclosing part 551 of the enclosure 550, shaped to receive part of the helicopter 510, opens away from the lower enclosing part 552, releasing the helicopter 510 out of the enclosure 550.

The decision of top vs. side deploy may be made based on the host vehicle design. The top-deploy may be simpler and more universally applicable (e.g., since it only requires an upward clearance), but the system and method disclosed herein covers such alternative orientations as well.

Regardless of orientation, the core components (e.g., secure locks 166a, 166b; a platform 162 or track to move the helicopter 110, 210, 310, 410, 510; and a coordinated unfolding mechanism 160) remain integral to the system 110, 510.

Alternate Rotorcraft Embodiments. The description of rotorcraft 110, 510 has focused on a particular coaxial design sized for Mars. However, the integrated system concept applies broadly.

The rotorcraft 110, 510 may be a different type of drone, such as a multi-rotor (e.g., quadrotor, hexacopter, etc.) where arms and propellers (e.g., blades) fold for storage. In such a case, the enclosure 150, 250, 350, 450, 550 may be shaped accordingly, and deployment may involve unfolding the arms. The enclosure 150, 250, 350, 450, 550 and method may still protect and deploy the craft in a similar fashion.

The size and mass of the rotorcraft 110, 510 may change. For instance, a smaller system might have a 2 kg helicopter carrying a 300 g payload, with an enclosure of correspondingly reduced dimensions. Conversely, a larger system might encompass a 10 kg helicopter with 2 kg payload for heavier-duty missions. The design principles scale: larger motors, bigger rotors, and a larger box with a stronger actuator, if needed. The modular nature means missions can choose an aerial system sized to their needs, and the enclosure 150, 550 may be tailored (e.g., while using the same basic pattern of a few locks 166a, 166b and a lift mechanism 160).

In one embodiment, multiple rotorcraft may be included in one enclosure (e.g., two smaller helicopters each in their own compartment of a single enclosure, deployed one after the other). This may provide redundancy or cooperative exploration. In such a scenario, the enclosure may have two separate doors or a single door with sequential deployment mechanisms. This is an extension of the concept and demonstrates its flexibility.

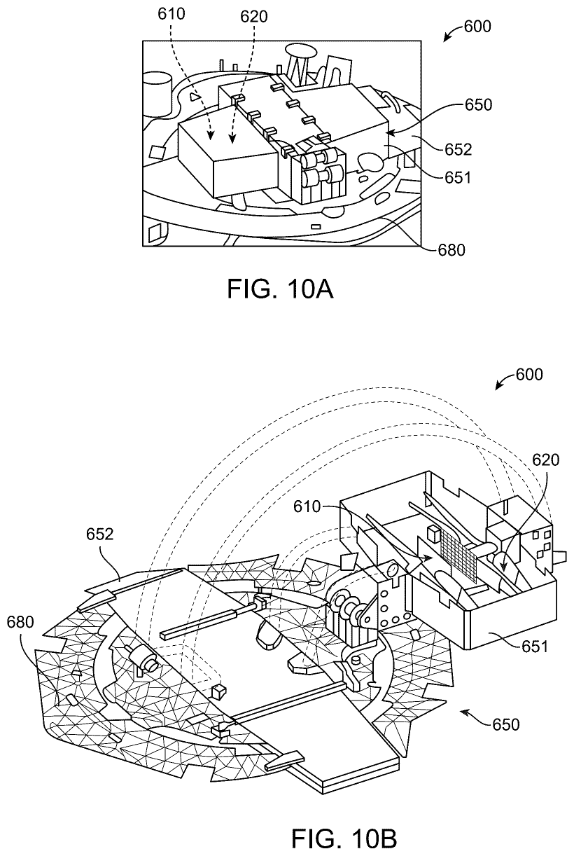

FIG. 10A depicts a perspective view of an integrated aerial exploration system 600 in its stowed configuration prior to deployment, according to another embodiment. Two helicopters 610, 620 are folded and secured inside the enclosure 650, and the enclosure 650 is closed.

FIG. 10B depicts a perspective view of the system 600 of FIG. 10A during the deployment sequence. The top enclosing part, or top lid, 651 of the enclosure 650, is shaped to receive the two helicopters 610, 620, and opens away from the bottom part 652 of the enclosure 650.

FIGS. 10A-10B also depict a deck 680 of the host vehicle/lander, the surface on which the enclosure 650 is mounted (e.g., the diagram's bottom area). Once the helicopters 610, 620 are deployed, it will take off from near this deck 680 and fly to retrieve sample tubes.

FIGS. 2-4 and 6A-10B show the critical moment during deployment of helicopter on Mars: when the lid of the enclosure opens, the lift platform raises the helicopter with legs extended and wheels deployed out of the enclosure, such that the locks and tether of the helicopter release.

At this point, the helicopter is fully unfolded and ready to begin operations. First, it will next drive off the platform on its wheels a short distance (if needed for clearance), then spin up the rotors and take off. Second, using its navigation cameras and guidance algorithms, it can fly to a sample cache, land nearby, then drive to a sample tube and pick it up with the arm. Third, the helicopter may then return to the lander, drop the tube for retrieval by the sample transfer arm, possibly recharge, and repeat if more tubes need fetching. This modular system ensures that the helicopter may be delivered to Mars safely and then perform the complex “fly, drive, grab” mission to help return Mars samples to Earth.

Once free on the surface, the helicopter 110, 610 may be commanded by the lander or an orbiter to begin its flight, but it may also autonomously take off after a preset delay. The disclosed system and method doesn't hinge on the specifics of flight control, but it is worth noting that because the helicopter 110, 610 uses heritage flight software, it can stabilize after take-off and navigate to targets using camera-based guidance and inertial sensing. Moreover, with the improved capability, it can travel over a kilometer per flight and thus perform significant exploration tasks. After flight, it can land back near the lander or at a new location. If it lands close enough and precisely, it could even re-enter the vicinity of the enclosure 150, 650 or even re-dock (though re-docking is not a current requirement, the enclosure 150 to 650 is largely out of the way after deployment). Re-docking for repeated launches and landings is possible and contemplated.

In the integrated design embodiment, the role of the host spacecraft may be minimal—essentially to carry the module, or system, 100, 200, 300, 400, 500, 600 to Mars and send a deployment command. The helicopter module 100, 600 handles its own release and is designed not to impart any negative effects on the host (for example, during deployment, the forces are low and well-contained). By isolating the complexity inside the module 100, 600, the mission can reap the benefits of aerial mobility with much less engineering overhead on the lander/rover side. Also, because the helicopter 110, 610 may be fully assembled and tested on Earth as a unit (and even come with its enclosure 150 to 650 in a ready-to-mount form), late integration into a mission is possible. One could decide to add an aerial capability to a mission relatively late if mass allows, which is very hard to do with a custom approach.

In one embodiment of the top deployment, the deployment system may provide a simple housing layout, straightforward door seal, and in-line release launch locks. In one embodiment of the side deployment, the deployment system may provide Simple housing layout, door seal, and be able to hold the helicopter from top or bottom. In one embodiment of the compact deployment, the deployment system may be compact and volume efficient, using all direct rotary deployment, no sliding, a wide mounting orientation ability, and in-line release launch locks. In one embodiment of the top deployment, and end deploy design may include a simple housing layout and door seal. In one embodiment of the top deployment, a pivot from middle design, may provide a simple housing layout, a door seal, and be able to deploy by placing on a surface.

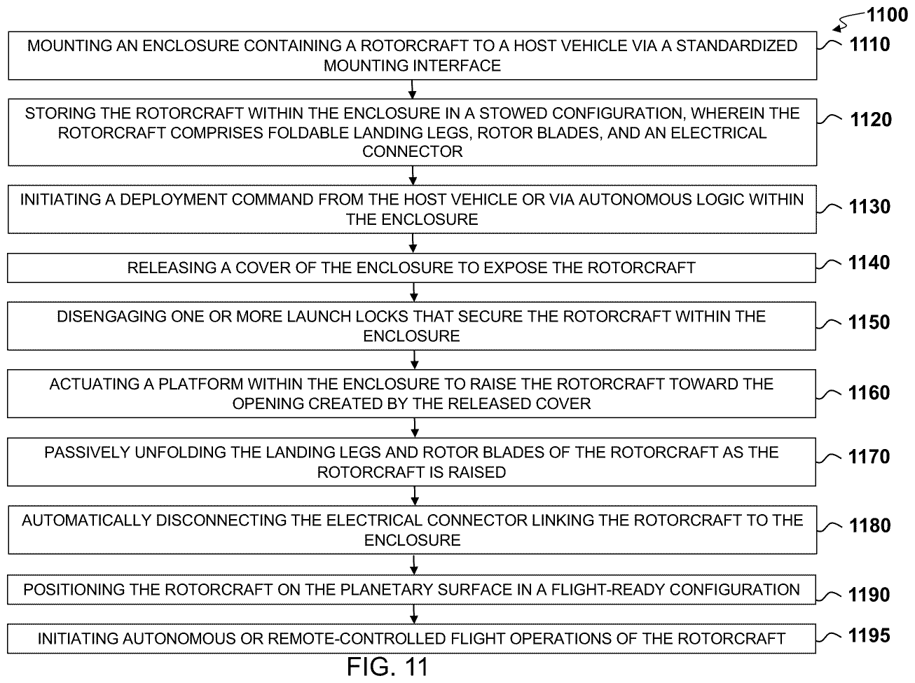

FIG. 11 depicts a high level flowchart of a method embodiment 1100 for deploying a rotorcraft from an integrated aerial exploration system on a planetary surface may include the following steps: mounting an enclosure containing a rotorcraft to a host vehicle via a standardized mounting interface (step 1110); storing the rotorcraft within the enclosure in a stowed configuration, wherein the rotorcraft comprises foldable landing legs, rotor blades, and an electrical connector (step 1120); initiating a deployment command from the host vehicle or via autonomous logic within the enclosure (step 1130); releasing a cover of the enclosure to expose the rotorcraft (step 1140); disengaging one or more launch locks that secure the rotorcraft within the enclosure (step 1150); actuating a platform within the enclosure to raise the rotorcraft toward the opening created by the released cover (step 1160); passively unfolding the landing legs and rotor blades of the rotorcraft as the rotorcraft is raised (step 1170); automatically disconnecting the electrical connector linking the rotorcraft to the enclosure (step 1180); positioning the rotorcraft on the planetary surface in a flight-ready configuration (step 1190); and initiating autonomous or remote-controlled flight operations of the rotorcraft (step 1195).

In an alternate embodiment, the method may be where the deployment command is initiated by a sensor-based logic system within the enclosure configured to detect environmental readiness conditions. In one embodiment, the method may be where the cover of the enclosure comprises a hinged top lid configured to open passively upon release of a latch mechanism. In one embodiment, the method may be where the launch locks comprise an upper lock configured to constrain lateral movement of the rotorcraft mast and a lower lock configured to secure the rotorcraft fuselage to the platform. In one embodiment, the method may be where the platform is actuated by a motorized screw jack configured to raise the rotorcraft at a controlled rate. In one embodiment, the method may be where the unfolding of the landing legs and rotor blades occurs passively by spring bias as the rotorcraft clears the enclosure. In one embodiment, the method may be where the electrical connector comprises a breakaway plug configured to disconnect automatically upon vertical displacement of the rotorcraft. In one embodiment, the method may be where the rotorcraft is positioned on the planetary surface with its center of gravity within a support polygon defined by the extended landing legs. In one embodiment, the method may be where the flight operations of the rotorcraft are initiated by a remote command from the host vehicle or an orbiting relay. In one embodiment, the method may be where the enclosure further comprises vibration-damping supports configured to absorb mechanical shocks during launch and landing. In one embodiment, the method may be where the enclosure includes a dust seal around the cover configured to inhibit particulate intrusion during descent and landing. In one embodiment, the method may be where the rotorcraft comprises a coaxial dual-rotor configuration with counter-rotating blades mounted on a common mast. In one embodiment, the method may be where the rotorcraft includes a scientific payload selected from the group consisting of a magnetometer, spectrometer, camera system, robotic arm, and ground mobility wheels.

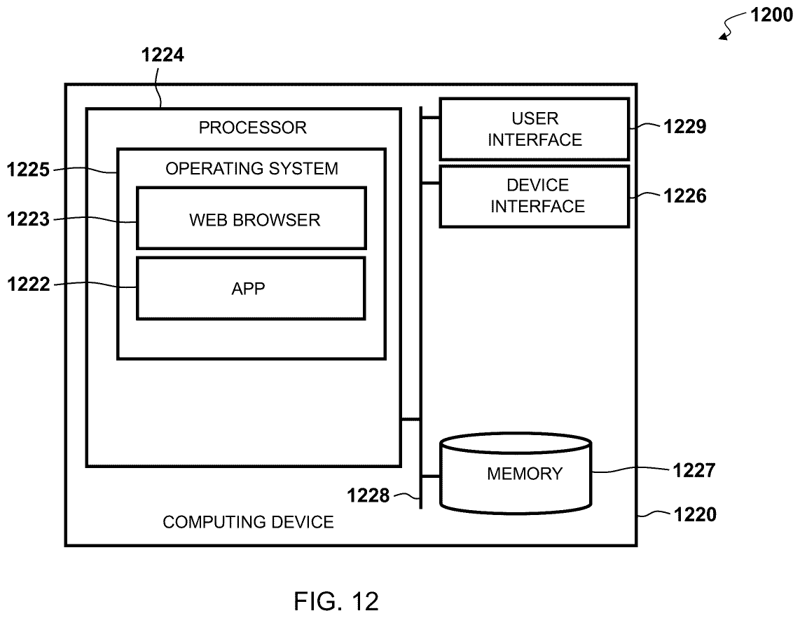

FIG. 12 illustrates an example of a top-level functional block diagram of a computing device embodiment 1200. The example operating environment is shown as a computing device 1220 comprising a processor 1224, such as a central processing unit (CPU), addressable memory 1227, an external device interface 1226, e.g., an optional universal serial bus port and related processing, and/or an Ethernet port and related processing, and an optional user interface 1229, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 1228. In some embodiments, via an operating system 1225 such as one supporting a web browser 1223 and applications 1222, the processor 1224 may be configured to execute steps of a process establishing a communication channel and processing according to the embodiments described above.

System embodiments include computing devices such as a server computing device, a buyer computing device, and a seller computing device, each comprising a processor and addressable memory and in electronic communication with each other. The embodiments provide a server computing device that may be configured to: register one or more buyer computing devices and associate each buyer computing device with a buyer profile; register one or more seller computing devices and associate each seller computing device with a seller profile; determine search results of one or more registered buyer computing devices matching one or more buyer criteria via a seller search component. The service computing device may then transmit a message from the registered seller computing device to a registered buyer computing device from the determined search results and provide access to the registered buyer computing device of a property from the one or more properties of the registered seller via a remote access component based on the transmitted message and the associated buyer computing device; and track movement of the registered buyer computing device in the accessed property via a viewer tracking component.

Accordingly, the system may facilitate the tracking of buyers by the system and sellers once they are on the property and aid in the seller's search for finding buyers for their property. The figures described below provide more details about the implementation of the devices and how they may interact with each other using the disclosed technology.

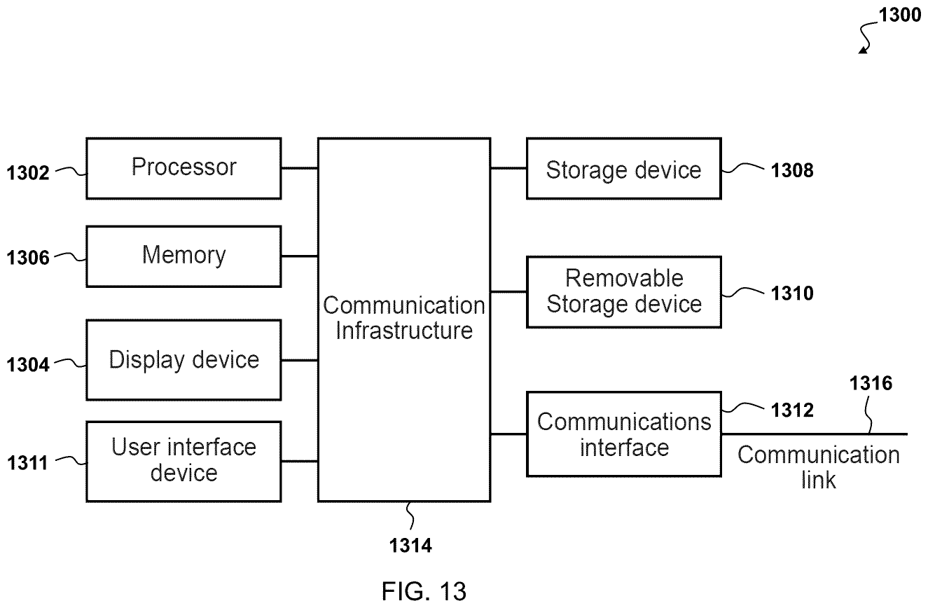

FIG. 13 is a high-level block diagram 1300 showing a computing system comprising a computer system useful for implementing an embodiment of the system and process, disclosed herein. Embodiments of the system may be implemented in different computing environments. The computer system includes one or more processors 1302, and can further include an electronic display device 1304 (e.g., for displaying graphics, text, and other data), a main memory 1306 (e.g., random access memory (RAM)), storage device 1308, a removable storage device 1310 (e.g., removable storage drive, a removable memory module, a magnetic tape drive, an optical disk drive, a computer readable medium having stored therein computer software and/or data), user interface device 1311 (e.g., keyboard, touch screen, keypad, pointing device), and a communication interface 1312 (e.g., modem, a network interface (such as an Ethernet card), a communications port, or a PCMCIA slot and card). The communication interface 1312 allows software and data to be transferred between the computer system and external devices. The system further includes a communications infrastructure 1314 (e.g., a communications bus, cross-over bar, or network) to which the aforementioned devices/modules are connected as shown.

Information transferred via communications interface 1314 may be in the form of signals such as electronic, electromagnetic, optical, or other signals capable of being received by communications interface 1314, via a communication link 1316 that carries signals and may be implemented using wire or cable, fiber optics, a phone line, a cellular/mobile phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1312. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

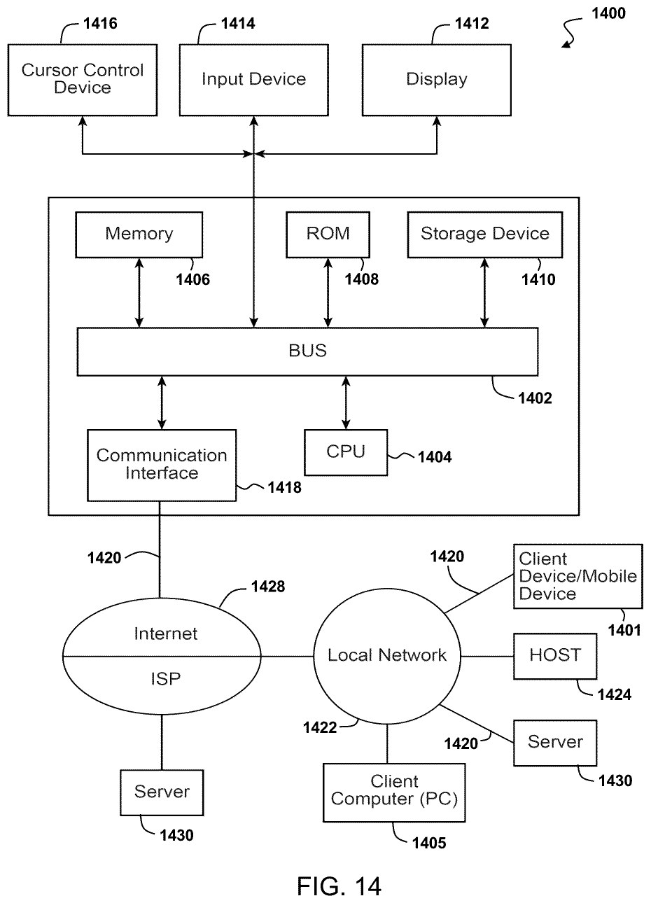

FIG. 14 shows a block diagram of an example system 1400 in which an embodiment may be implemented. The system 1400 includes one or more client devices 1401 such as consumer electronics devices, connected to one or more server computing systems 1430. A server 1430 includes a bus 1402 or other communication mechanism for communicating information, and a processor (CPU) 1404 coupled with the bus 1402 for processing information. The server 1430 also includes a main memory 1406, such as a random access memory (RAM) or other dynamic storage device, coupled to the bus 1402 for storing information and instructions to be executed by the processor 1404. The main memory 1406 also may be used for storing temporary variables or other intermediate information during execution or instructions to be executed by the processor 1404. The server computer system 1430 further includes a read only memory (ROM) 1408 or other static storage device coupled to the bus 1402 for storing static information and instructions for the processor 1404. A storage device 1410, such as a magnetic disk or optical disk, is provided and coupled to the bus 1402 for storing information and instructions. The bus 1402 may contain, for example, thirty-two address lines for addressing video memory or main memory 1406. The bus 1402 can also include, for example, a 32-bit data bus for transferring data between and among the components, such as the CPU 1404, the main memory 1406, video memory and the storage 1410. Alternatively, multiplex data/address lines may be used instead of separate data and address lines.

The server 1430 may be coupled via the bus 1402 to a display 1412 for displaying information to a computer user. An input device 1414, including alphanumeric and other keys, is coupled to the bus 1402 for communicating information and command selections to the processor 1404. Another type or user input device comprises cursor control 1416, such as a mouse, a trackball, or cursor direction keys for communicating direction information and command selections to the processor 1404 and for controlling cursor movement on the display 1412.

According to one embodiment, the functions are performed by the processor 1404 executing one or more sequences of one or more instructions contained in the main memory 1406. Such instructions may be read into the main memory 1406 from another computer-readable medium, such as the storage device 1410. Execution of the sequences of instructions contained in the main memory 1406 causes the processor 1404 to perform the process steps described herein. One or more processors in a multi-processing arrangement may also be employed to execute the sequences of instructions contained in the main memory 1406. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1404 for execution. Such a medium may take many forms, including but not limited to, non-volatile media, volatile media, and transmission media. Non-volatile media includes, for example, optical or magnetic disks, such as the storage device 1410. Volatile media includes dynamic memory, such as the main memory 1406. Transmission media includes coaxial cables, copper wire and fiber optics, including the wires that comprise the bus 1402. Transmission media can also take the form of acoustic or light waves, such as those generated during radio wave and infrared data communications. Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1404 for execution. For example, the instructions may initially be carried on a magnetic disk of a remote computer. The remote computer can load the instructions into its dynamic memory and send the instructions over a telephone line using a modem. A modem local to the server 1430 can receive the data on the telephone line and use an infrared transmitter to convert the data to an infrared signal. An infrared detector coupled to the bus 1402 can receive the data carried in the infrared signal and place the data on the bus 1402. The bus 1402 carries the data to the main memory 1406, from which the processor 1404 retrieves and executes the instructions. The instructions received from the main memory 1406 may optionally be stored on the storage device 1410 either before or after execution by the processor 1404.

The server 1430 also includes a communication interface 1418 coupled to the bus 1402. The communication interface 1418 provides a two-way data communication coupling to a network link 1420 that is connected to the worldwide packet data communication network now commonly referred to as the Internet 1428. The Internet 1428 uses electrical, electromagnetic, or optical signals that carry digital data streams. The signals through the various networks and the signals on the network link 1420 and through the communication interface 1418, which carry the digital data to and from the server 1430, are exemplary forms or carrier waves transporting the information.

In another embodiment of the server 1430, interface 1418 is connected to a network 1422 via a communication link 1420. For example, the communication interface 1418 may be an integrated services digital network (ISDN) card or a modem to provide a data communication connection to a corresponding type of telephone line, which can comprise part of the network link 1420. As another example, the communication interface 1418 may be a local area network (LAN) card to provide a data communication connection to a compatible LAN. Wireless links may also be implemented. In any such implementation, the communication interface 1418 sends and receives electrical electromagnetic or optical signals that carry digital data streams representing various types of information.

The network link 1420 typically provides data communication through one or more networks to other data devices. For example, the network link 1420 may provide a connection through the local network 1422 to a host computer 1424 or to data equipment operated by an Internet Service Provider (ISP). The ISP in turn provides data communication services through the Internet 1428. The local network 1422 and the Internet 1428 both use electrical, electromagnetic, or optical signals that carry digital data streams. The signals through the various networks and the signals on the network link 1420 and through the communication interface 1418, which carry the digital data to and from the server 1430, are exemplary forms or carrier waves transporting the information.

The server 1430 can send/receive messages and data, including e-mail, program code, through the network, the network link 1420 and the communication interface 1418. Further, the communication interface 1418 can comprise a USB/Tuner and the network link 1420 may be an antenna or cable for connecting the server 1430 to a cable provider, satellite provider or other terrestrial transmission system for receiving messages, data, and program code from another source.

The example versions of the embodiments described herein may be implemented as logical operations in a distributed processing system such as the system 1400 including the servers 1430. The logical operations of the embodiments may be implemented as a sequence of steps executing in the server 1430, and as interconnected machine modules within the system 1400. The implementation is a matter of choice and can depend on performance of the system 1400 implementing the embodiments. As such, the logical operations constituting said example versions of the embodiments are referred to for e.g., as operations, steps, or modules.

Similar to a server 1430 described above, a client device 1401 can include a processor, memory, storage device, display, input device and communication interface (e.g., e-mail interface) for connecting the client device to the Internet 1428, the ISP, or LAN 1422, for communication with the servers 1430.

The system 1400 can further include computers (e.g., personal computers, computing nodes) 1405 operating in the same manner as client devices 1401, where a user can utilize one or more computers 1405 to manage data in the server 1430.

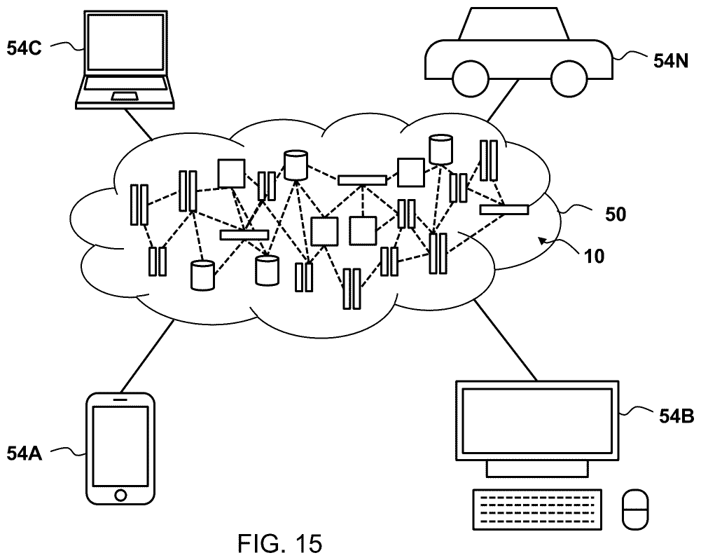

Referring now to FIG. 15, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or UAV system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 15 are intended to be illustrative only and that computing nodes 10 and cloud computing environment 50 can communicate with any type of computerized device over any type of network and/or network addressable connection (e.g., using a web browser).

The foregoing detailed description outlines the construction and operation of the integrated aerial exploration system according to various embodiments. It should be understood that the specific materials, dimensions, and sequences described are illustrative of the best mode of implementing the invention as contemplated by the inventors, but not limiting. For instance, other hinge mechanisms, locking devices, or even a different sequence (e.g., lid and lift could be simultaneous or lid could open partway then lift starts, etc.) could be employed.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. An integrated aerial exploration system for deployment on a planetary surface, the system comprising:
a rotorcraft configured for flight in a low-density atmosphere and adapted to carry a scientific payload;
an enclosure housing the rotorcraft during launch, transit, and landing, the enclosure including a mounting interface for attachment to a host vehicle and a cover movable to provide an opening for deployment of the rotorcraft; and
a deployment mechanism configured, upon activation, to move the rotorcraft from within the enclosure to a position outside the enclosure through said opening;
wherein activation of the deployment mechanism automatically releases the rotorcraft from the enclosure and deploys one or more stowed components of the rotorcraft into a flight-ready configuration for aerial operation.

2. The system of claim 1, wherein the rotorcraft comprises a coaxial dual-rotor helicopter having two counter-rotating rotors mounted on a common mast and no tail rotor, for providing lift and directional control in the low-density atmosphere.

3. The system of claim 1, wherein the rotorcraft includes a payload interface configured to support the scientific payload of at least about 1 kilogram (kg), allowing the rotorcraft to carry one or more scientific instruments during flight.

4. The system of claim 1, wherein the cover of the enclosure is a hinged top lid, and the deployment mechanism comprises an actuator that raises a platform on which the rotorcraft is mounted, thereby lifting the rotorcraft upward and out through the opening created by the open lid.

5. The system of claim 4, wherein the rotorcraft has foldable landing legs that are restrained within the enclosure when the rotorcraft is stowed, and wherein raising the platform causes the landing legs to unfold and an electrical connector linking the rotorcraft to the enclosure to disconnect without manual intervention.

6. The system of claim 1, wherein the enclosure comprises a mounting plate with a bolt pattern conforming to a standardized spacecraft interface, allowing the system to be mounted to the host vehicle using pre-existing attachment points.

7. The system of claim 1, wherein the rotorcraft further comprises an onboard communication system configured for direct wireless communication with a remote receiver or relay orbiting said planetary surface, without requiring a communication relay through the host vehicle during flight.

8. The system of claim 1, wherein the rotorcraft includes at least one of: ground mobility and manipulation features as part of said scientific payload, selected from the group consisting of: deployable wheels for surface driving and a robotic arm for sample acquisition, the enclosure being dimensioned to accommodate said features in the stowed configuration.

9. The system of claim 1, wherein a combined mass of the rotorcraft and the enclosure is less than about 35 kilograms, making the integrated system suitable as a secondary payload on a planetary lander.

10. The system of claim 1, wherein said planetary surface is Mars and the rotorcraft is configured to perform controlled flight in the Martian atmosphere with a flight endurance of 2-3 minutes and a flight range of at least 1 kilometer per flight.

11. The system of claim 1, wherein the deployment mechanism is configured to deploy the rotorcraft vertically upward from the enclosure when the enclosure is mounted on a horizontal surface of the host vehicle, and wherein the deployment mechanism is reconfigured to deploy the rotorcraft outwardly when the enclosure is mounted on a vertical surface of the host vehicle.

12. The system of claim 1, further comprising at least one of: one or more safety interlocks and sensors to verify that the cover is open to a sufficient position before the rotorcraft is moved by the deployment mechanism, and to confirm release of the rotorcraft before initiating flight, thereby preventing inadvertent rotorcraft activation while it is partially stowed.

13. The system of claim 1, wherein the enclosure includes dust seals around the cover to inhibit dust and debris from entering the enclosure prior to deployment, thereby protecting the rotorcraft during descent and after landing.

14. The system of claim 1, wherein the rotorcraft is configured to be at least partially powered or recharged by the host vehicle prior to deployment via an electrical connector between the rotorcraft and the enclosure, and wherein said electrical connector is the component that automatically disconnects upon deployment.

15. The system of claim 1, wherein the deployment mechanism and the rotorcraft are arranged such that center of gravity of the rotorcraft remains within a stable range relative to a platform throughout deployment, thereby ensuring the rotorcraft stands upright on the surface when released.

16. The system of claim 1, wherein the enclosure further comprises one or more vibration-damping supports positioned to contact portions of the rotorcraft during launch and landing, said supports preventing excessive movement or stress on those portions by absorbing vibration and shocks.

17. A method comprising:
receiving, by an enclosure, a deployment command;
releasing a top cover latch restraining a lid of the enclosure in response to the deployment command;
opening the lid of the enclosure once the top cover latch is released;
releasing one or more launch locks once the lid is open;
lifting a helicopter out of the enclosure on a platform via an actuator once the one or more launch locks are released;
deploying one or more landing legs of the helicopter once the helicopter is lifted and clears the enclosure; and
disconnecting an electrical connector linking the helicopter to the enclosure once the helicopter is lifted to a separation point.

18. The method of claim 17, further comprising:
launching the helicopter from the platform.

19. The method of claim 18, further comprising:
retracting the platform into the enclosure once the helicopter is launched.

20. The method of claim 19, further comprising
closing the lid of the enclosure once the platform is retracted.
